(19) United States
(12) Patent Application Publication
(10) Pub. No.: US 2023/0084171 A1
(43) Pub. Date: Mar. 16, 2023

(54) TELESCOPIC LED GROW LIGHT

(71) Applicant: SHENZHEN AURORA TECHNOLOGY LIMITED, SHENZHEN (CN)

(72) Inventor: QINGBO XIE, SHENZHEN (CN)

(21) Appl. No.: 17/525,984

(22) Filed: Nov. 15, 2021

(30) Foreign Application Priority Data
Sep. 16, 2021 (CN) 202122243680.8

(51) Int. Cl. A01G 9/24; F21V 21/14; F21V 21/22

(52) U.S. Cl. CPC A01G 9/249; F21V 21/145; F21V 21/22; F21Y 2105/10

(57) ABSTRACT

The present invention discloses a telescopic LED grow light, which comprises a power supply box, a power supply holder, a plurality of lamp bodies and a telescopic frame, wherein the power supply box is located in a middle of the LED grow light, two power supply holders are respectively fixed at both ends of the power supply box, the power supply holder is also used for fixing the lamp bodies located at both sides of the power supply box, and the lamp bodies are fixed by the telescopic frame for expanding or contracting. The present invention has the beneficial effects that the PPFD value is changed by adjusting the telescopic function of the grow light. The function of the grow light that can be retracted and reduced for storage is very practical, in addition, it is also convenient for transportation after contraction.

### FIELD OF TECHNOLOGY

The present invention relates to the lighting field, in particular to a telescopic LED grow light.

### BACKGROUND

An LED grow light is a kind of artificial light source which uses LED (Light Emitting Diode) as a light emitter to meet the light conditions required for plant photosynthesis. LED is considered as the most promising artificial light source for the future implementation of plant cultivation and has a good development prospect.

For the existing grow light, it is complicated to change PPFD value. When changing the Photosynthetic Photo Flux Density (PPFD) value by adjusting a height between the grow light and the plant, it has strict requirements for space, such as being high enough. There are also some difficulties in operation, that is, being placed low, the PPFD value density becomes too high to be easy to hurt plants, when the grow light is put high, the PPFD value density is too low to be not able to meet the normal growth of plants.

When a plant area in an original space becomes smaller, but the area irradiated by the grow light is not changed, it will cause waste of electric energy. For example, during the seedling raising period, a range of plants to be irradiated is small as usual, and the irradiation area of the grow light is not changed, so the electric energy is not fully utilized. However, the existing grow lights are large in size and inconvenient to store and transport.

### SUMMARY

In order to overcome the defects of the prior art, the present invention provides an LED grow light which adjusts the PPFD value through a telescopic structure and is stored by telescoping. It is realized by the following technical solution.

A telescopic LED grow light includes a power supply box, a power supply holder, a plurality of lamp bodies and a telescopic frame, wherein the power supply box is located in a middle of the LED grow light, two power supply holders are respectively fixed at both ends of the power supply box, the power supply holder also serves to fix the lamp bodies at both sides of the power supply box, and the lamp bodies are fixed by the telescopic frame for expanding or contracting.

Further, the power supply box is replaced with an integrated power supply. Further, the telescopic frame includes a movable bracket, a riveting buckle, a knob movable screw, a fixing screw and a sliding buckle, wherein two movable brackets are intersected and stacked in an X shape, and are fixed by the riveting buckle in the middle; a cross angle of the two movable brackets can be adjusted arbitrarily, and a telescopic function can be realized by adjusting the cross angle of the two movable brackets.

Further, the telescopic frame and the lamp body are multiple, a first telescopic frame is placed between a first lamp body and a second lamp body, and four ends of two movable brackets of the telescopic frame are fixed on the first lamp body and the second lamp body by the fixing screw, the sliding buckle and the knob movable screw; a second telescopic frame is placed between the second lamp body and a third lamp body, and four ends of two movable brackets of the second telescopic frame are respectively fixed on the second lamp body and the third lamp body; and a third telescopic frame is fixed on the third lamp body and a fourth lamp body.

Further, when the LED grow light is extended to a desired size, the telescopic frame is fixed by adjusting the knob movable screw, to fix a size of the LED grow light and prevent the LED grow light from sliding at will.

Further, after the grow light is extended and fixed, a movable support rod located below the power supply box rotates horizontally by 90 degrees, and is connected to a lower end of the riveting buckle through the fixing screw, to strengthen a stress support of the LED grow light.

Further, the telescopic frame of the LED grow light is replaced with a telescopic device.

Further, the telescopic device includes a telescopic rod, a fixing buckle, an adapter plug, a spring piece, a plug, wherein one telescopic device includes two telescopic rods and a number of fixing buckles, the telescopic rod consists of a number of telescopic tubes of the same length and different diameters, two first telescopic tubes of the same diameter are installed at each end of the adapter plug, and two second telescopic tubes are fitted to another ends of the two first telescopic tubes, wherein a diameter of the second telescopic tube is smaller than that of the first telescopic tube and is a size that can be inserted exactly into the first telescopic tube; two third telescopic tubes are respectively fitted to another ends of the two second telescopic tubes, wherein a diameter of the third telescopic tube is smaller than that of the second telescopic tube and is a size that can be inserted exactly into the second telescopic tube; and two ends of the last two telescopic tubes are blocked with plugs for waterproofing.

Further, the first telescopic tube and the second telescopic tube are provided with a limit at an interface overlap for preventing dislodgement when expanded, and when contracted, a tube with a smaller diameter is received in a tube with a larger diameter to achieve the telescopic function; and the second telescopic tube and the third telescopic tube are provided with a limit at an interface overlap.

Further, the lamp body is installed between two telescopic rods, one lamp body is installed at a spacing of a length of a single telescopic tube, the number of the telescopic tubes is increased, and the lamp bodies with the number equivalent to the number of the telescopic tubes are provided.

The present invention has the beneficial effects:

the PPFD value is changed by adjusting the telescopic function of the grow light. For the rational use in agricultural facilities, when the plant area is small, the grow light can be contracted, and when the plant area is large, the grow light can be expanded to make full use of electric energy.

The function of the grow light that can be retracted and reduced for storage is very practical, in addition, it is also convenient for transportation after contraction, saving costs and resources.

### BRIEF DESCRIPTION OF THE DRAWINGS

FIG. 1 is a top view structural diagram of a first embodiment of an LED grow light of the present invention.

FIG. 2 is a structural diagram of the first embodiment of the LED grow light of the present invention.

FIG. 3 is a structural diagram of a lamp body of the first embodiment of the LED grow light of the present invention.

FIG. 4 is a structural diagram of a telescopic frame of the first embodiment of the LED grow light of the present invention.

FIG. 5 is a top view of a telescopic structure of the first embodiment of the LED grow light of the present invention.

FIG. 6 is a diagram of the telescopic structure of the first embodiment of the LED grow light of the present invention.

FIG. 7 is a diagram of the telescopic structure of a second embodiment of the LED grow light of the present invention.

FIG. 8 is an expanded structural diagram of the second embodiment of the LED grow light of the present invention.

FIG. 9 is a bottom view structural diagram of the second embodiment of the LED grow light of the present invention.

FIG. 10 is a top view structural diagram of a third embodiment of the LED grow light of the present invention.

FIG. 11 is a structural diagram of the third embodiment of the LED grow light of the present invention.

FIG. 12 is a structural diagram of a lamp body of the third embodiment of the LED grow light of the present invention.

FIG. 13 is a structural diagram of a telescopic device of the third embodiment of the LED grow light of the present invention.

FIG. 14 is a top view of a telescopic structure of the third embodiment of the LED grow light of the present invention.

FIG. 15 is a diagram of the telescopic structure of the third embodiment of the LED grow light of the present invention.

FIG. 16 is an expanded structural diagram of a fourth embodiment of the LED grow light of the present invention.

FIG. 17 is a diagram of a telescopic structure of the fourth embodiment of the LED grow light of the present invention.

FIG. 18 is a structural diagram of a telescopic device of the fourth embodiment of the LED grow light of the present invention.

Reference signs in the drawings:

lamp body—1, radiator—11, light source board—12, PCB lamp panel—121, LED lamp bead—122, end cap—13, power supply box—2, telescopic frame—3, movable bracket—31, riveting buckle—32, knob movable screw—33, fixing screw—34, sliding buckle—35, power supply holder—4; telescopic device—5, telescopic rod—51, telescopic tube—511, fixing buckle—52, adapter plug—53, spring piece—54, plug—55, push rod—56, gasket—57, press switch—58, movable support rod—6, screw—7, ring—8, wire—9, LED grow light—10.

### DETAILED DESCRIPTION OF THE EMBODIMENTS

A clear and complete description of the technical solution in the embodiments of the present invention will be made below in conjunction with the drawings in the embodiments of the present invention are present. Obviously, the described embodiments are only part of the embodiments of the present invention, but not all of them. Based on the embodiments of the present invention, all other embodiments obtained by those ordinarily skilled in the art without exerting creative effort fall within the scope of protection of the present invention.

As shown in FIG. 2, it is a first embodiment of the present invention, which relates to a telescopic LED grow light 10 composed of a lamp body 1, a power supply box 2, a telescopic frame 3, a power supply holder 4, a movable support rod 6, a screw 7 and a ring 8.

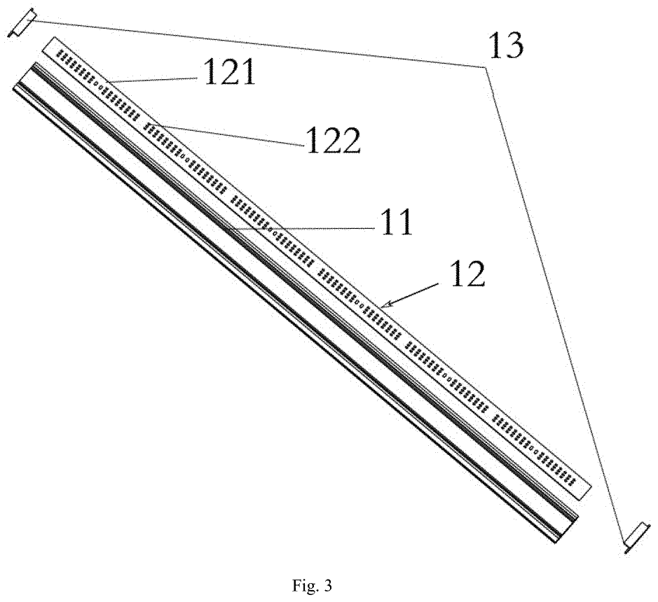

As shown in FIG. 3, the lamp body 1 includes a radiator 11, a light source board 12 and an end cap 13, wherein the light source board 12 is composed of a PCB lamp panel 121 and an LED lamp bead 122. The radiator is located at a back of the lamp body, and its material includes one of aluminum, alloy material, iron, steel and injection molded parts; and a substrate of the PCB board 121 includes one of an aluminum substrate, a copper substrate, and a composite substrate. The radiator 11 is located at an upper portion of the light source board 12, and there are two end caps 13, disposed at two ends of the light source board and the radiator, respectively, for fixing the light source board and the radiator.

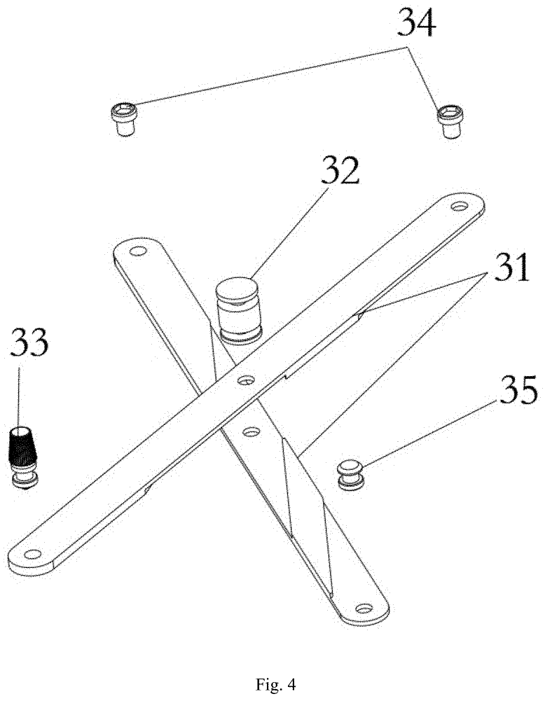

As shown in FIG. 4, the telescopic frame 3 includes a movable bracket 31, a riveting buckle 32, a knob movable screw 33, a fixing screw 34, and a sliding buckle 35. One telescopic frame 3 is composed of two movable brackets 31 which are intersected and stacked in an X shape, and are fixed by the riveting buckle 32 in the middle; and a cross angle of the two movable brackets can be adjusted arbitrarily, and a telescopic function can be realized by adjusting the cross angle of the two movable brackets.

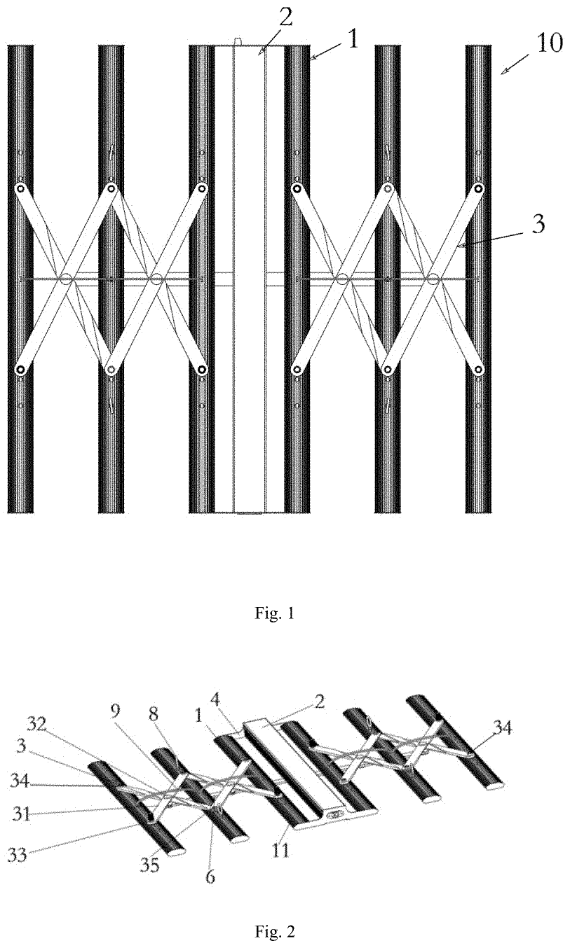

As shown in FIG. 1, one telescopic frame is placed between a first lamp body and a second lamp body. Four ends of the two movable brackets 31 of the telescopic bracket 3 are respectively fixed on the two lamp bodies by two fixing screws 34, one sliding buckle 35 and one knob movable screw 33. A second telescopic frame is placed between the second lamp body and a third lamp body, and four ends of two movable brackets 31 of the second telescopic frame are respectively fixed on the second lamp body and the third lamp body, similarly, N telescopic frames and N lamp bodies are added to form grow lights with different power.

As shown in FIG. 2, after the grow light is extended and fixed, the movable support rod 6 located below the lamp body is connected to a lower end of the riveting buckle 32 through the screw 7, for strengthening a stress support of the LED grow light.

The telescopic function of the grow light can be realized by adjusting the cross angle of the two movable brackets of the telescopic frame, thus changing the PPFD value. When the grow light is contracted, a distance between the lamp bodies decreases, that is, the distance between lamp beads becomes smaller, when the PPFD value increases; and when the grow light is expanded, the distance between the lamp bodies increases, that is, the distance between the lamp beads becomes larger, when the PPFD value decreases. According to this principle, for the rational use in agricultural facilities, when the plant area is small, the grow light can be contracted, and when the plant area is large, the grow light can be expanded to make full use of electric energy.

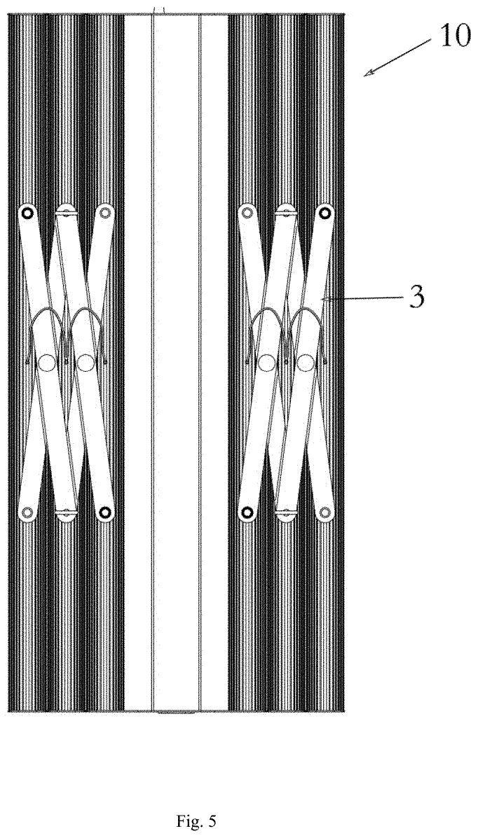

As shown in FIGS. 5-6, the function of the grow light that can be retracted and reduced for storage is very practical, which features in small space occupation and convenient storage. In addition, it is also convenient for transportation and packaging after contraction, saving costs and resources.

When the LED grow light 10 is extended to the required size, the telescopic frame can be fixed by adjusting the knob movable screw, thereby fixing the size of the grow light and preventing the grow light from sliding at will. After the LED grow light 10 is extended and fixed, the movable support rod 6 below the power supply box can be horizontally rotated by 90 degrees, and then fixed below the LED grow light through the screw 7, which can be used for strengthening the stress support. The movable support rod 6 is located below the power supply box after being contracted, and the assembly is flexible.

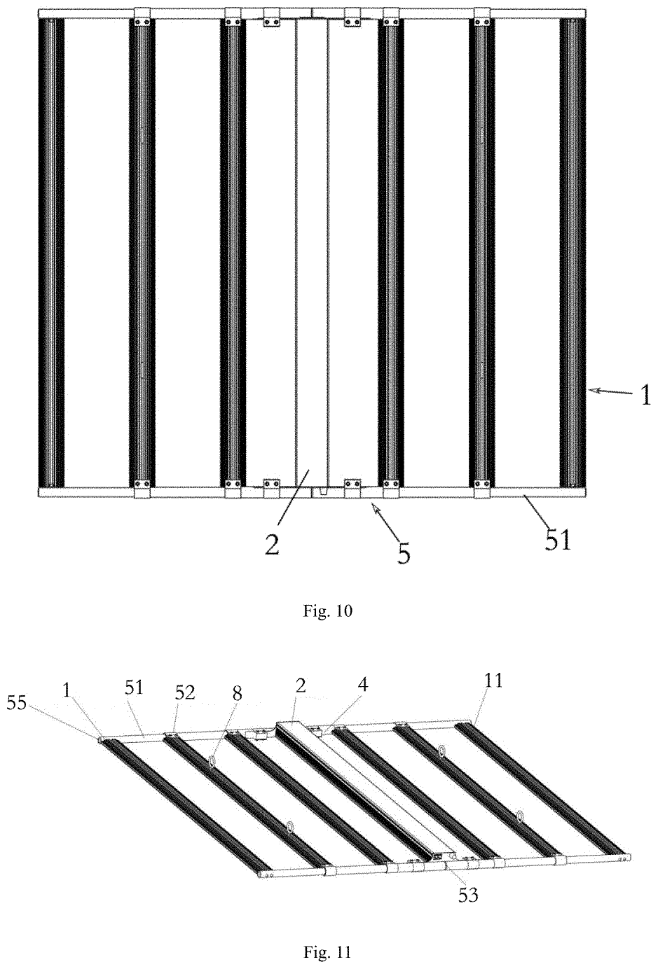

As shown in FIG. 10, the movable support rod 6 is provided with a number of semicircular grooves for mating with a lower end of the riveting buckle 32 so that the movable support rod is clamped into a lower portion of the riveting buckle 32, and then fixed by a thumb screw in the middle. The screw 7 is preferably a thumb screw to facilitate assembly.

As shown in FIG. 2, the power supply box 2 includes a power supply, a control system, and input and output ports. An internal structure of the power supply box is not modified in the present invention and is not described in detail here. The power supply box can be externally disposed in the middle of the grow light, and is respectively fixed at both ends of two lamp bodies 1 by two power supply holders 4. The power supply and the lamp body are connected by wires 9.

Rings 8 are used for hanging the LED grow light, and the rings and roof are connected by hanging lines, so that the LED grow light can be hung up.

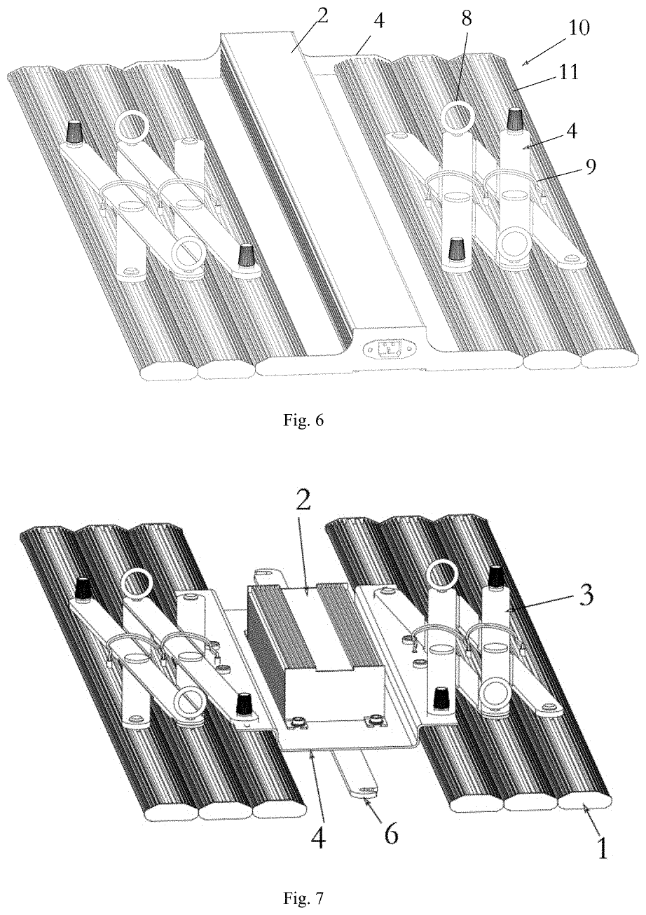

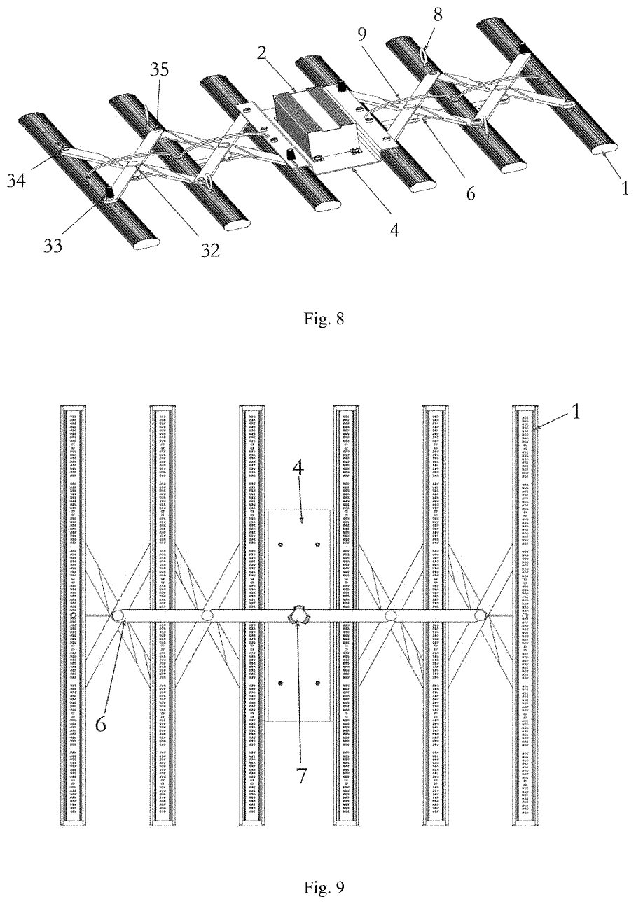

As shown in FIGS. 7-9, it is the second embodiment of the present invention. The power supply box 2 is replaced by an integrated power supply, which is installed on the power supply holder 4, and the power supply holder is connected with ends of the telescopic frames 3 at both ends of the LED grow light. Four ends of the two movable brackets 31 of the telescopic bracket 3 are respectively fixed on the two lamp bodies by two fixing screws 34, one sliding buckle 35 and one knob movable screw 33. A second telescopic frame is placed between two lamp bodies, and four ends of two movable brackets 31 of the second telescopic frame are respectively fixed on the two lamp bodies, similarly, N telescopic frames and N lamp bodies are added to form grow lights with different power.

The power supply of the first embodiment and the second embodiment can be selected as an integrated power supply or a power supply box as required. The integrated power supply is connected with the lamp body by wires, and the integrated power supply is small, which is convenient to install and simple in production process; and the power supply box is more beautiful and the overall structure is coordinated, the power supply box includes a power supply, a control system and an input and output port, two power supply holders are used to fix the power supply box respectively at both ends of the two lamp bodies.

Other configurations of the second embodiment are substantially the same as those of the first embodiment and will not be described repeatedly here.

As shown in FIG. 11, it is a third embodiment of the present invention, which relates to a telescopic LED grow light composed of a lamp body 1, a power supply box 2, a telescopic device 5, a power supply holder 4 and a ring 7. Compared with the first embodiment, the telescopic device that has the same telescopic adjustment function is used to replace the telescopic frame.

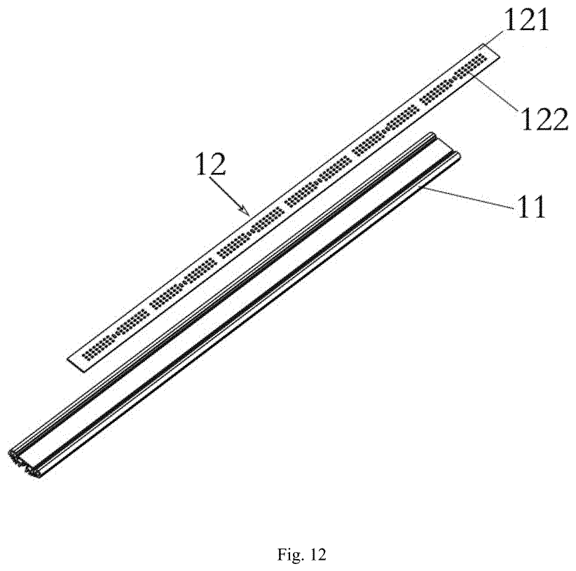

As shown in FIG. 12, the lamp body 1 includes a radiator 11 and a light source board 12, wherein the light source board 12 is composed of a PCB lamp panel 121 and an LED lamp bead 122. A material of the radiator 11 includes one of aluminum material, alloy material, iron, steel and injection molded parts; and a substrate of the PCB board 121 includes one of an aluminum substrate, a copper substrate, and a composite substrate.

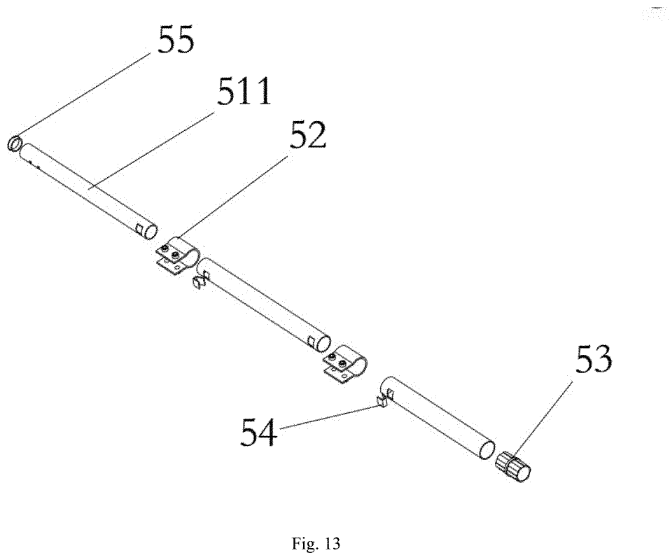

As shown in FIG. 13, the telescopic device 5 includes a telescopic rod 51, a fixing buckle 52, a adapter plug 53, a spring piece 54, and a plug 55. One telescopic frame includes two telescopic rods and a plurality of fixing buckles 52. One telescopic rod 51 is composed of a plurality of telescopic tubes 511 having the same length and different diameters. First telescopic tubes 511 having the same diameter are respectively installed at both ends of a adapter plug 53, and two second telescopic tubes are fitted into another ends of two first telescopic tubes, wherein a diameter of the second telescopic tubes is smaller than that of the first telescopic tubes and is a size that can be inserted exactly into the first telescopic tube.

The fixing buckle 52 is located on the telescopic rod, and two opposite fixing buckles are used for fixing the lamp body 1.

Two third telescopic tubes 511 are then respectively fitted to another ends of the two second telescopic tubes 511, wherein a diameter of the third telescopic tube is smaller than that of the second telescopic tube and is a size that can be inserted exactly into the second telescopic tube. Similarly, the Nth telescopic tubes are installed at follows, and two ends of the last two telescopic tubes are blocked with plugs 55 for waterproofing. There is a limit (not marked in the figure) at an interface overlap of the telescopic tubes, and the limit adopts a mode of mating spring piece and groove, which is a common limit structure, such as the limit structure of umbrella. When expanded and stretched to the maximum position, the spring piece 54 will get stuck in the groove to prevent it from falling off. When contracting, the tube with a smaller diameter can be accommodated in the tube with a larger diameter, thus realizing the telescopic function.

As shown in FIG. 10, one grow light has one telescopic frame, the lamp body 1 is installed between two telescopic rods 51, and one lamp body is installed at a spacing of a length of a single telescopic tube and fixed by the fixing buckles, so that by increasing the number of telescopic tubes, grow lights with different power can be assembled.

The telescopic function of the grow light can be realized by adjusting the length of two telescopic rods of the telescopic frame, thus changing the PPFD value. When the grow light is contracted, a distance between the lamp bodies decreases, that is, the distance between lamp beads becomes smaller, when the PPFD value increases; and when the grow light is expanded, the distance between the lamp bodies increases, that is, the distance between the lamp beads becomes larger, when the PPFD value decreases. According to this principle, for the rational use in agricultural facilities, when the plant area is small, the grow light can be contracted, and when the plant area is large, the grow light can be expanded to make full use of electric energy.

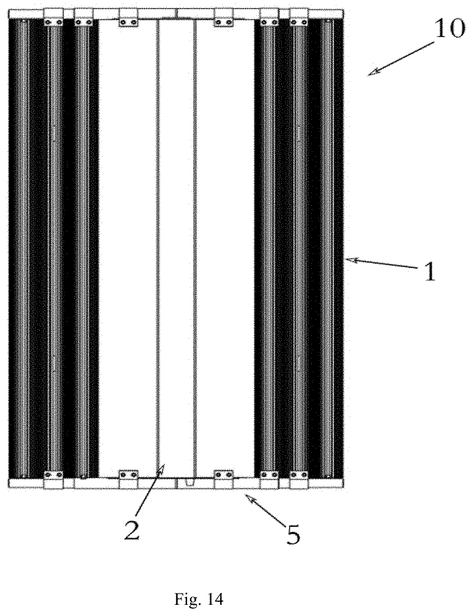

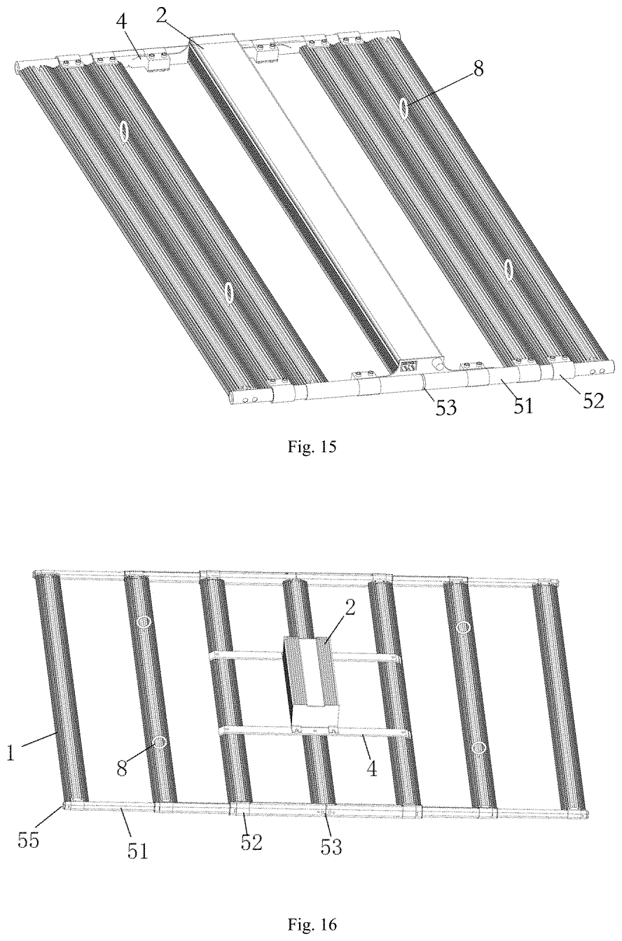

As shown in FIGS. 14-15, the function of the grow light that can be retracted and reduced for storage is very practical, which features in small space occupation and convenient storage. In addition, it is also convenient for transportation and packaging after contraction, saving costs and resources.

As shown in FIG. 10, the power supply box 2 includes a power supply, a control system, and input and output ports. An internal structure of the power supply box is not modified in the present invention and is not described in detail here. The power supply box can be externally disposed in the middle of the grow light, and is respectively fixed at both ends of two lamp bodies 1 by two power supply holders 4. The power supply and the lamp body are connected by wires 9, and the wires 9 can be routed in the telescopic rod.

Rings 8 are used for hanging the LED grow light, and the rings and roof are connected by hanging lines, so that the LED grow light can be hung up.

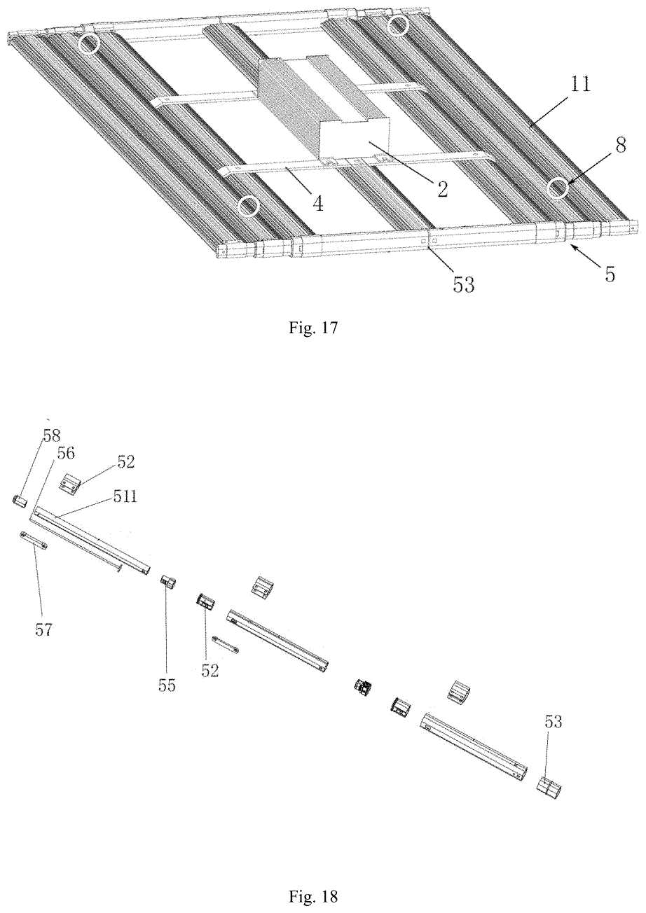

FIGS. 16-18 show a fourth embodiment of the present invention, where the power supply box 2 is replaced by an integrated power supply installed on a power supply holder 4, and both ends of the power supply holder are respectively fixed on the radiator 11 of the lamp bodies at both ends of the power supply box.

The telescopic device 5 includes a telescopic rod 51, a fixing buckle 52, a adapter plug 53, a spring piece 54, and a plug 55. One telescopic frame includes two telescopic rods and a plurality of fixing buckles 52. One telescopic rod 51 is composed of a plurality of telescopic tubes 511 having the same length and different diameters. First telescopic tubes 511 having the same diameter are respectively installed at both ends of a adapter plug 53, and two second telescopic tubes are fitted into another ends of two first telescopic tubes, wherein a diameter of the second telescopic tubes is smaller than that of the first telescopic tubes and is a size that can be inserted exactly into the first telescopic tube.

The assembly of the telescopic device 5 is shown in FIG. 18.

As shown in FIGS. 13-14, the telescopic device 5 also includes a toggle switch located at one end of the telescopic rod. A push rod 56 of the press switch is inserted into the first telescopic tube from one end thereof, a key portion of the press switch 58 is fitted in a port of the first telescopic tube, and a pipe plug switch or a plug 55 is fitted in the other end of the first telescopic tube. A gasket is installed at one ends of the first telescopic tube and the second telescopic tube, respectively. Other telescopic tubes have the same structure.

The principle of telescopic device is: when the telescopic rod is extended to the maximum position, the plug switch and sleeve at the interface between the telescopic tube and the telescopic tube can play a limiting role to prevent falling off, since a small end of the plug switch enters from a large end of the sleeve and comes out from a small end of the sleeve, and a large end of the pipe plug switch is larger than the small end of the sleeve, so it plays a limiting role. In addition, there is also a spring piece on the pipe plug switch (refer to FIG. 13). When extended and stretched to the maximum position, the spring piece will get stuck in the groove to prevent easy contraction. When the press switch is started, the push rod will touch the spring piece of the pipe plug switch, and the telescopic rod can be easily retracted at this time.

The power supply of the third embodiment and the fourth embodiment can be selected as an integrated power supply or a power supply box as required. The integrated power supply is connected with the lamp body by wires, and the integrated power supply is small, which is convenient to install and simple in production process; and the power supply box is more beautiful and the overall structure is coordinated, the power supply box includes a power supply, a control system and an input and output port, two power supply holders are used to fix the power supply box respectively at both ends of the two lamp bodies.

According to the first to the fourth embodiments of the present invention, the LED grow light can retract and combine a plurality of lamp bodies together through a telescopic frame or a similar telescopic device. According to a contracting degree of the lamp bodies, the PPFD value can be adjusted, and the number of lamp bodies can be set according to requirements. By increasing or decreasing the number of telescopic frames or telescopic devices, the number of lamp bodies is determined, and the illumination is applied to plants with different sizes or different requirements for light intensity, which is practical.

Although the embodiments of the present invention have been shown and described, it will be understood to those of ordinary skill in the art that various changes, modifications, substitutions and variations may be made to these embodiments without departing from the principle and spirit of the present invention, the scope of present invention is defined by the appended claims and their equivalents.

What is claimed is:

1. A telescopic LED grow light, comprising a power supply box, a power supply holder, a plurality of lamp bodies and a telescopic frame, wherein the power supply box is located in a middle of the LED grow light, two power supply holders are respectively fixed at both ends of the power supply box, the power supply holder also serves to fix the lamp bodies located at both sides of the power supply box, and the lamp bodies are fixed by the telescopic frame therebetween for expanding or contracting.

2. The telescopic LED grow light according to claim 1, wherein the telescopic frame comprises a movable bracket, a riveting buckle, a knob movable screw, a fixing screw and a sliding buckle, wherein two movable brackets are intersected and stacked in an X shape, and are fixed by the riveting buckle in the middle; and a cross angle of the two movable brackets can be adjusted arbitrarily, and a telescopic function is realized by adjusting the cross angle of the two movable brackets.

3. The telescopic LED grow light according to claim 2, wherein the telescopic frame and the lamp body are multiple, a first telescopic frame is placed between a first lamp body and a second lamp body, and four ends of the two movable brackets are fixed on the first lamp body and the second lamp body by the fixing screw, the sliding buckle and the knob movable screw; a second telescopic frame is placed between the second lamp body and a third lamp body, and four ends of the two movable brackets are respectively fixed on the second lamp body and the third lamp body; and a third telescopic frame is fixed on the third lamp body and a fourth lamp body.

4. The telescopic LED grow light according to claim 2, wherein when the LED grow light is extended to a required size, the knob movable screw serves to fix the telescopic frame, to prevent the grow light from sliding at will.

5. The telescopic LED grow light according to claim 4, wherein after the LED grow light is extended and fixed, a movable support rod located below the power supply box rotates horizontally by 90 degrees, and is connected to a lower end of the riveting buckle through the fixing screw, to strengthen a stress support of the LED grow light.

6. The telescopic LED grow light according to claim 1, wherein the telescopic frame of the LED grow light is replaced with a telescopic device.

7. The telescopic LED grow light according to claim 6, wherein the telescopic device comprises a telescopic rod, a fixing buckle, an adapter plug, a spring piece, and a plug, wherein the telescopic device comprises two telescopic rods and a number of fixing buckles, the telescopic rod consists of a number of telescopic tubes of the same length and different diameters, two first telescopic tubes of the same diameter are respectively installed at both end of the adapter plug, and two second telescopic tubes are fitted to another ends of the two first telescopic tubes, wherein a diameter of the second telescopic tube is smaller than that of the first telescopic tube and is of a size that can be inserted exactly into the first telescopic tube; two third telescopic tubes are respectively fitted to another ends of the two second telescopic tubes, wherein a diameter of the third telescopic tube is smaller than that of the second telescopic tube and is of a size that can be inserted exactly into the second telescopic tube; and two ends of the last two telescopic tubes are blocked with plugs for waterproofing.

8. The telescopic LED grow light according to claim 7, wherein the first telescopic tube and the second telescopic tube are provided with a limit at an interface overlap for preventing dislodgement when expanded, and when contracted, a tube with a smaller diameter is received in a tube with a larger diameter to achieve a telescopic function; and the second telescopic tube and the third telescopic tube are provided with a limit at an interface overlap.

9. The telescopic LED grow light according to claim 7, wherein the lamp body is installed between two telescopic rods, one lamp body is installed at a spacing of a length of a single telescopic tube, by increasing the number of the telescopic tubes, the lamp bodies with the number equivalent to the number of the telescopic tubes are provided.

10. The telescopic LED grow light according to claim 1, wherein the power supply box is replaced with an integrated power supply.
